(19) United States
(12) Patent Application Publication
(10) Pub. No.: US 2004/0065084 A1
(43) Pub. Date: Apr. 8, 2004

(54) Fast-fill brake master cylinder

(76) Inventors: Glen Coleman, Warwickshire (GB); Edmond John Wimbush Harrison, Warwickshire (GB)

Correspondence Address: Robert L Stearns, Howard & Howard Attorneys, 39400 Woodard Avenue, Bloomfield Hills, MI, 48304-5151, US

(21) Appl. No.: 10/450,621

(22) PCT Filed: Dec. 17, 2001
(86) PCT No.: PCT/GB01/05571

(30) Foreign Application Priority Data
Dec. 16, 2000 (GB) 0030793.4

(51) Int. Cl. B60T 11/20

(52) U.S. Cl. 60/562

(57) ABSTRACT

A master cylinder assembly (24) for an automotive braking system is adapted to provide hydraulic functions simulating the effect of a traditional vacuum servo device but without the expense associated with such a servo device. The master cylinder (24) comprises tandem high pressure small diameter cylinder portions (30, 32) to generate high pressure for the main brake-applying phase of any given brake application. These tandem high pressure cylinders are connected to the usual split hydraulic systems (26, 28) of the vehicle, for example diagonally split front/rear wheels. The master cylinder further comprises a fast-fill larger diameter portion (34) for achieving immediate clearance take-up and fast entry into the simulated servo portion of the brake application. The fast-fill chamber has a floating piston (40) dividing it into twin hydraulically isolated chambers (36, 38) serving the split hydraulic systems (26, 28) which are also subsequently pressurised independently by the tandem high pressure cylinder.

This invention relates to brake master cylinder and other systems. An example of the application of the invention is to a spot-type disc brake system for automotive vehicles in which there is a requirement for a twin or split hydraulic control arrangement providing fail-safe functions to meet legislative or other requirements. An example of such a system is a diagonally-split braking system having diagonally-opposed front/rear wheel braking systems interconnected and being hydraulically independent so far as actuation and control is concerned. Some embodiments of the invention apply equally to a front/rear split (non-diagonal) brake control system.

In relation to such braking systems there is a requirement for the provision of a master cylinder arrangement in which several inter-related functions are provided in addition to the hydraulic independence of the twin or split systems, including an ability to fast-fill the recuperative hydraulic volume of the system after brake application and to provide this function without the entire duplication of all the hydraulic systems and components.

Another function which is desirable is to enable the fast-fill function to operate in a sequential manner with the main (high pressure) function, in a simple manner, and with series connection of the master cylinder portions providing the functions, and in a manner whereby driver-originating mechanical actuating thrust is arranged to mechanically actuate the relevant master cylinder portions without using hydraulic thrust transmission.

A further functional requirement of relevance to the embodiments of the invention concerns the provision of differential pressure portions in the master cylinder system (for example a fast-fill portion and full-pressure portion) and the inter-relationship of such portions to the provision, in such a braking system, of a vacuum servo function, or like servo function, and the need to reduce the cost of or even partially or fully eliminate such servo systems if a more economical mode for providing a equivalent function can be found. For example, if the master cylinder itself could generate the requisite level of hydraulic pressure to achieve the necessary actuation of the wheel cylinders of the braking system so as to offer the driver the level of braking response achieved with a servo system, then this might well be a significant cost saving step unless there were offsetting cost increases in the master cylinder itself.

In this latter connection, certain classes of brake offer particular advantages. For example, a twin disc (or more discs) disc brake system offers the potential to operate at significantly lower hydraulic pressures than conventional disc brake systems, and thus to be able to assist or complement a master cylinder system which itself has the potential to reduce the need for the provision of a vacuum-operated (or any other) servo system.

Accordingly, an object of the invention is to provide hydraulic systems and a master cylinder assembly offering improvements in relation one or more aspects of the requirements discussed above, or generally, and thus, according to the present invention there is provided a method and apparatus as defined in the accompanying claims.

In an embodiment of the invention described below there is provided a hydraulic braking system in which there is provided a master cylinder assembly comprising independent pairs of differential diameter cylinder portions disposed in series and adapted to be actuated sequentially by a control such as a mechanical brake operating lever eg a foot pedal. and arranged to operate respective independent hydraulic braking sub-systems.

The master cylinder assembly includes (hydraulically independent) tandem high pressure cylinder portions disposed (mechanically) in series together with associated series-connected larger diameter fast-fill portions adapted to be hydraulically connected to the high pressure cylinder portions to effect a preliminary fast-fill function in relation to the hydraulic circuits for which the high pressure cylinders provide the main actuating pressure generation to effect brake actuation during use. The larger diameter master cylinder portions are arranged to take up with a minimum of brake pedal travel the clearances due to recuperation of the hydraulic systems which occur under the action of return springs upon release of the brake pedal at the end of a given braking cycle, so as to recommence braking immediately when so desired and with the minimum of pedal travel (due to the diameter differential between the fast-fill and high-pressure cylinder portions) accordingly.

The mechanical disposition and arrangement of the larger diameter (fast-fill) and high-pressure cylinder portions, and their hydraulic interconnections is such that when the preliminary fast-fill portion of the master cylinder's actuating stroke has occurred, the larger diameter fast-fill portion of the cylinder becomes connected to tank/reservoir so that further actuation of the master cylinder in the actuation direction causes direct mechanical actuation of the high pressure cylinder portions (without the need for series-transmission of thrust hydraulically through the fast-fill cylinder) with resultant generation of high hydraulic pressure so that such is available for direct transmission to the (diagonally opposed or front/rear opposed) pairs of brake-actuating wheel cylinders so as to have a comparable effect to the corresponding brake system in which a vacuum-operated or other servo device is provided.

The differential diameter master cylinder portions together with tandem isolated high pressure cylinder portions provide the driver with a system in which braking system responsiveness (brake pedal “feel” and vehicle retardation fed back to the driver through the brake pedal and through the vehicle seat) combine to give that combination of system responses which together impart to the driver the requisite level of confidence in the effectiveness of the braking system, despite the absence of a costly servo device, the use of which would have been in accordance with established practices in the automotive industry.

Moreover, a further aspect of the embodiments of the invention described below provides a further enhancement of the effects which combine, in a braking system, to impart driver confidence in relation to the readily-available retardation effect which is accessible by application of a minimum of foot pedal effort. In this regard, the embodiments provide, in association with a master cylinder incorporating one or more of the features and performance aspects of the master cylinder and associated hydraulic systems discussed above, the provision, at least in relation to the front wheels of an automotive vehicle, and preferably in relation to all four wheels, of a multiple sliding-disc disc brake system in which the required actuation pressure is significantly lower than that required for conventional disc brake systems.

Thus, in the embodiments described below, there is provided a spot-type disc brake system for automotive vehicles, particularly adapted for the mass-production vehicle market, notably for medium and/or small vehicle sizes (such as the Ford Fiesta or General Motors Corsa as available in Europe in 2000), in which the braking system is able to operate in a manner significantly different from that which has been established over significant numbers of decades. This is achieved by providing all the major performance features required by regulatory provision and marketplace demand, without the need to incur the significant expense of the provision of a power-operated servo system. The embodiments utilise instead a combination of features which cooperate to provide the remarkable result that by use of a brake pedal-actuated system not incorporating a servo device and not requiring above average mechanical actuation foot loading from the driver (in relation to current norms of driver foot pedal effort for the now universally-provided servo systems) there is provided a braking system meeting these modern requirements.

To put it another way, the braking system disclosed in the embodiments abandons the tradition of servo assistance for minimising brake pedal effort, returns to the master cylinder as a means for generating the required high hydraulic pressure, maximises driver confidence (in terms of system feedback) by utilising differential diameter master cylinder portions, whereby a first characteristic of servo operation is obtained (with minimum pedal travel) by means of the fast-fill cylinder portion, namely immediate and responsive take-up of clearances due to brake-release system recuperation, at a touch of the brake pedal. Then, likewise in the system disclosed in the embodiments, the other main feature of servo-operated brakes is provided, namely the generation of high pressure hydraulic actuation fluid with a requirement for a minimum of brake pedal load (by means of the high pressure cylinder portions. Moreover, this reduced requirement for load is still further minimised in the embodiments by the adoption of the multi disc brake configuration whereby brake friction pad area is increased with a proportion at decrease in the requirement for high pressure actuation fluid.

Thus, the embodiments described provide a combination of features which interact to offer an effect clearly contrary to established norms in the automotive industry and yet not requiring the adoption of hydraulic systems or other components requiring anything other than relatively simple manufacturing techniques and feature in themselves.

There is disclosed in GB-A-2 129 520 (Lucas) a master cylinder assembly for a vehicle hydraulic braking system comprising cylinder portions of the quick-fill type and employing a pedal-operated piston of stepped outline working in a complementary stepped bore in a housing. No disclosure is provided as to how such a system could be applied to a braking system requiring hydraulically-independent actuation of split braking systems.

There is disclosed in U.S. Pat. No. 4,086,70 (General Motors) a dual circuit quick take-up master cylinder assembly in which the relevant portions of the master cylinder provide quick take-up and main-pressure functions for (in each case) both the front and rear wheel brake circuits, at the relevant different stages in a given braking operation. No disclosure is provided as to how an economic and compact master cylinder assembly could be constructed to provide independence of the fast fill functions for the separate circuits and independence of the main pressure functions for the circuits.

Embodiments of the invention will now be described by way of example with reference to the accompanying drawings in which:

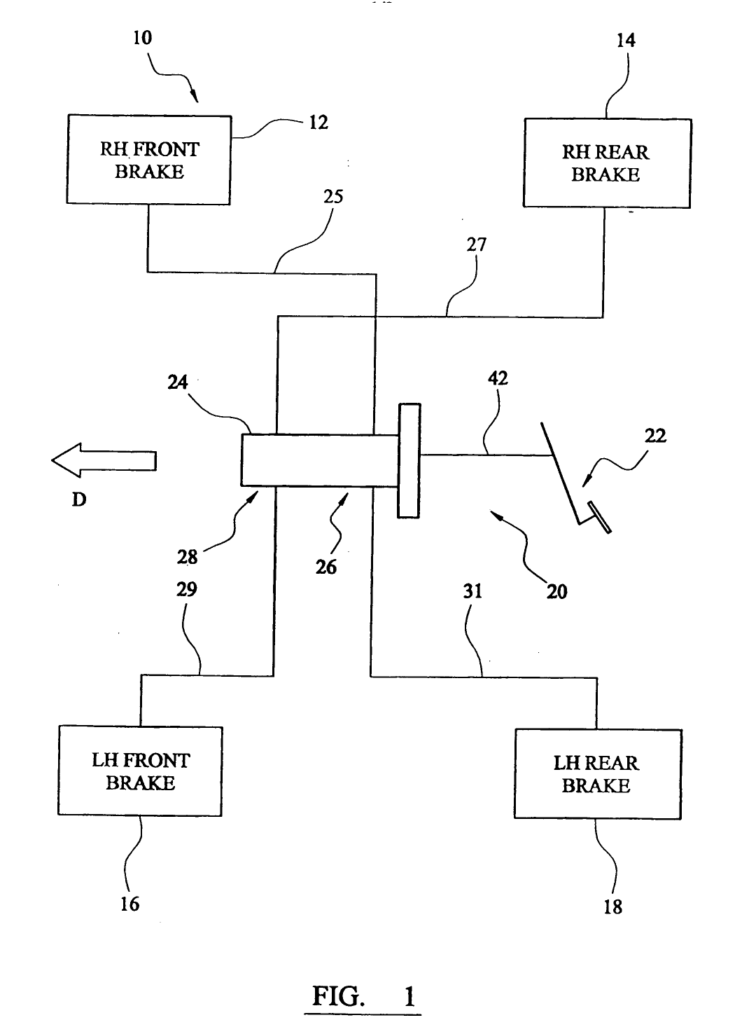

FIG. 1 shows a circuit diagram for an automotive braking system comprising a hydraulic tandem master cylinder supplying hydraulic fluid to pairs of diagonally split front and rear vehicle wheel brakes, under the control of a driver's foot pedal;

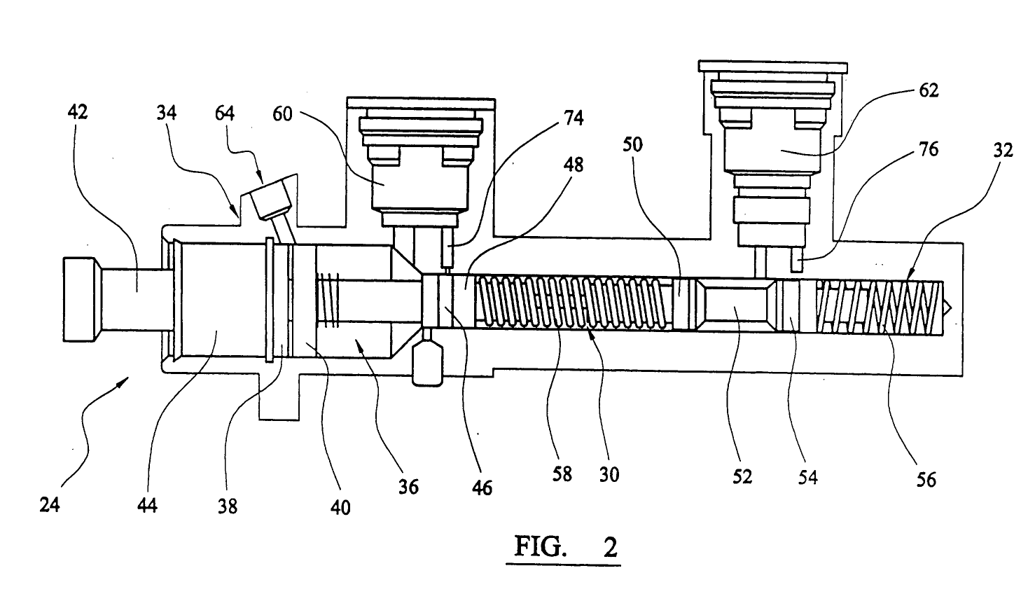

FIG. 2 shows a longitudinal section through the tandem master cylinder of FIG. 1;

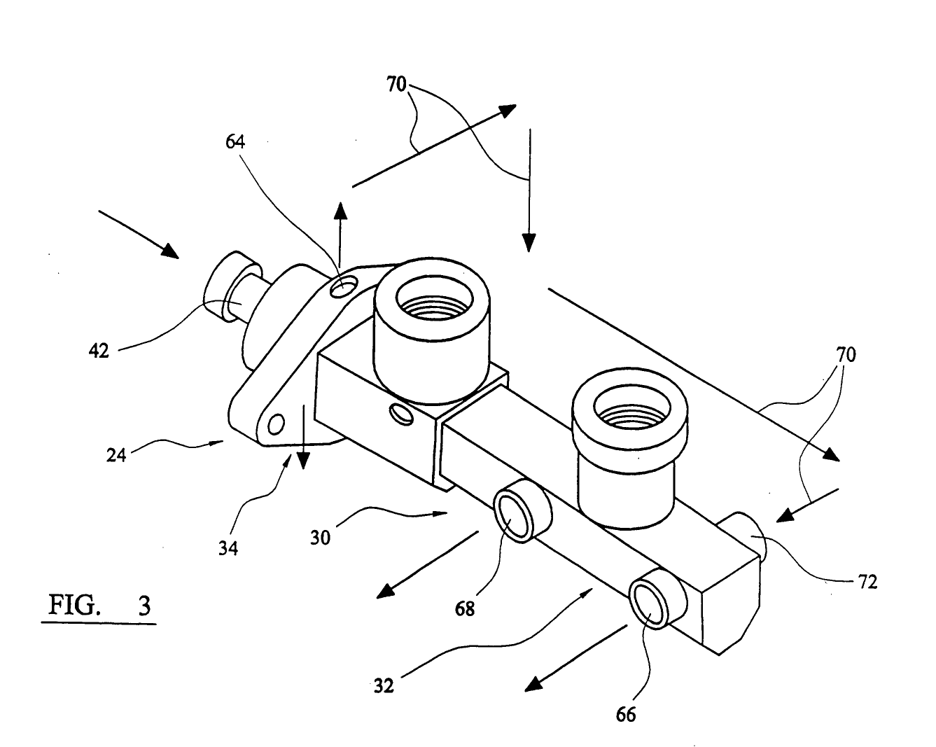

FIG. 3 shows a second view of the master cylinder of FIGS. 1 and 2, as seen in perspective from above and to one side.

As shown in the drawings an automotive braking system 10 comprises vehicle wheel brakes 12, 14, 16, and 18 comprising friction elements (not shown) actuated by actuator cylinders (also not shown).

A hydraulic control system 20 for the brakes 12 to 18 comprises a control in the form of a driver-operable brake foot pedal 22 arranged to actuate a hydraulic master cylinder 24 connected to the actuator cylinders of the wheel blades 12 to 18 by hydraulic lines 25, 27, 29, 31.

As shown in FIG. 1, the hydraulic control system 20 including master cylinder 24 comprises independent hydraulic sub-systems 26, 28 (see FIG. 1) controlling pairs of the actuator cylinders of the vehicle brakes 12 to 18, namely sub-system 26 controls the cylinders of brakes 14, 16 and sub-system 28 controls the cylinders of brakes 12, 18.

In FIG. 1, the direction of forward movement of the vehicle is indicated by arrow D. Turning now to the detailed structure of master cylinder 24, as shown in FIGS. 2 and 3, master cylinder 24 comprises tandem independent master cylinder portions 30, 32 connected to the hydraulic sub-systems 26, 28 to actuate same.

Furthermore master cylinder 24 further comprises a fast-fill cylinder 34 of larger diameter than the tandem master cylinder high pressure portions 30, 32 and connected thereto to effect a fast-filling function.

Before proceeding further with the description of the detailed structure of master cylinder 24, it needs to be noted that an important function of the master cylinder is to provide the braking system 10 with two stage operation of both of the independent hydraulic sub-systems. This is achieved by means of hydraulically independent cylinder portion pairs, each pair comprising a cylinder portion of each of two differing dimensions, as follows. Firstly, concerning the tandem master cylinder portions 30, 32, these are of such a relatively small diameter (with respect to the wheel cylinders of wheel brakes 12 to 18) that they are capable of generating the necessary high pressure and high brake-applying thrust to generate the required braking force at the brake fully-applied stage of any given brake application. In other words, because the tandem master cylinder portions 30, 32 are of relatively small diameter, they are able to generate a level of hydraulic pressure for delivery to the wheel brake cylinders such that the latter respond somewhat as if there were present a vacuum servo device or the like. Because at this stage of the brake application there is relatively very little movement between the components of the system, it is insignificant that the relatively small diameter of the master cylinder pistons would lead to a requirement for a long cylinder stroke if the cylinder were of one uniform diameter. Such is not the case. The arrangement is such that high pressure and high thrust are generated at precisely the portion of the operating stroke at which movement is minimal. To put it another way, a simulated servo means is provided by adaptation of the master cylinder so that the relatively small diameter of the tandem master cylinder portions are capable of generating the necessary high pressure and high brake applying thrust to simulate a vacuum servo or the like at the brake fully-applied stage of any given brake application. Thus, the servo-effect. As for the independent hydraulic sub-systems 26 and 28 and their inter relationship with the thus-adapted master cylinder, the position is as follows.

Thus, master cylinder 24 is constructed to provide two-stage operation of both of the independent hydraulic sub-systems 26, 28. This is achieved by means of hydraulically independent cylinder portion pairs, each pair comprising a fast-fill cylinder portion and one of the tandem master cylinder portions 30, 32. Thus fast-fill cylinder 34 is divided into primary and secondary hydraulically-isolated cylinder portions 36, 38, these being constituted by the single chamber of fast-fill cylinder 34 which is hydraulically divided into the portions 36, 38 by a piston 40. Thus, the hydraulically-independent cylinder pairs consist of primary master cylinder portion 30 and primary fast-fill chamber portion 36 constituting one pair, and secondary master cylinder portion 32 and secondary fast-fill chamber 38 constituting the other pair. Each cylinder of these cylinder pairs is of a differing cylinder diameter from the other thereof and as clearly shown in FIG. 2 the diameter ratio is of the order of 2:1 (the fast-fill chambers being of course of larger diameter).

Broadly, the mode of operation of the system is generally as follows. The fast-fill cylinder portion of each of the master cylinder portion pairs is adapted to enable clearances (generated by recuperation of the braking system following the previous brake application) to be taken up quickly as soon as the brake pedal is actuated, and the smaller diameter master cylinder portion is then adapted to multiply the force applied thereto by the foot pedal by a higher factor so as to generate the required braking force by means of the actuator cylinders acting on the friction elements of brakes 12 to 18.

Considering now the structural details by which this is achieved, these are as follows. The push rod 42 connects foot pedal 22 to master cylinder 24 and is connected to an end piston 44 in fast-fill cylinder 34. End piston 34 and divider piston 40 define the limits of secondary fast-fill cylinder portion 38. Primary fast-fill cylinder portion 36 is defined between divider piston 40 and a seal 46 formed at the left hand end (in FIG. 2) of the primary master cylinder portion 30 and carried by a slidable piston assembly 48 located within cylinder portion 30.

The other end of primary (high pressure) master cylinder portion 30 (at the right hand end of that cylinder portion in FIG. 2) is defined by a seal 50. Seal 50 is mounted on a spool-type piston member 52 carrying a further seal 54 defining the left hand end (in FIG. 2) of secondary (high pressure) master cylinder portion 32. Coiled compression springs 56, 58 act between, respectively, the right hand end wall of secondary master cylinder portion 32 and spool-type piston member 52, and between the left hand end of spool-type piston 52 and piston assembly 48. Springs 56 and 58 are of lesser and greater resilient capacity (in terms of resistence to compressive forces) respectively, for the reasons which will emerge below.

Hybrid valve assemblies 60, 62 provide for the hydraulic interconnection of the fast-fill cylinder portions 36, 38 respectively with the high pressure master cylinder portions 30, 32 and optionally (dependent on hydraulic pressure) with respective hydraulic reservoirs (not shown) in a manner to be described, and which will emerge from the following description of the mode of operation of the apparatus.

Broadly, the hydraulic system operates such that the fast-fill cylinder portions 36, 38 initially pressurise the brake actuating cylinders by supply of relatively low pressure/high volume fluid thereto via the primary and secondary (high pressure but not yet generating high pressure) master cylinder portions 30, 32. This takes up clearances arising from recuperation of the brake system after the previous brake application. Then, after an initial degree of piston and seal travel, the fast-fill cylinder portions are vented to tank and the high pressure actuation phase of the brake application ensues with the brake pedal thrust being applied to the smaller diameter piston assemblies 48 and 52 (and associated seals 50, 54) accordingly.

This mode of operation is achieved as follows.

Thrust from push rod 42 acting on end piston 44 generates (relatively) low pressure hydraulic fluid pressure in secondary fast-fill cylinder portion 38 which is transferred via port 64 to the space between seals 50 and 54, whereupon valve 62 permits such fluid flow, at pressures up to two bar, to be transferred to secondary master cylinder portion 32 from whence it proceeds via secondary outlet port 66 to one of the hydraulic sub systems 26, 28.

Likewise, for the other of the hydraulic sub systems 26, 28 divider piston 40 is subjected to the hydraulic pressure generated in secondary fast-fill cylinder portion 38 and generates corresponding hydraulic pressure in primary fast-fill portion 36 and this is transferred, in a similar manner via hybrid valve assembly 60 to primary master cylinder portion 30 and thus via a primary outlet port 68 (FIG. 3) to that other one of the hydraulic sub systems 26, 28.

In FIG. 3 there is indicated at 70 a diagrammatic representation of the hydraulic route for hydraulic pressure from port 64 of secondary fast-fill cylinder portion 38 to an inlet port 72 to secondary master cylinder portion 32. Thus far we have seen how the fast-fill cylinder portions 36, 38 operate to provide rapid take-up of braking clearances for initiation of braking. We turn next to the high pressure phase of the brake actuation process.

In simple terms the high pressure phase of the process is initiated by movement of seals 46, 54 respectively past the return ports 74, 76 of valves 60, 62 respectively. This prevents passage of hydraulic fluid from the fast-fill cylinder portions 36, 38 via the valves 60, 62 to the primary and secondary master cylinder portions 30, 32 and thus initiates pressurisation of the hydraulic fluid in those master cylinder portions directly by the piston and seal assemblies 48, 46 and 52, 54 accordingly. The sliding movement of seals 46, 54 past the return ports 74, 76 is permitted by compression of the (lower rate) compression spring 56 in secondary master cylinder portion 32. In the initial (fast-fill) phase of operation, the thrust from push rod 42 is applied to the entire axially-extending assembly of pistons 44, 40, 48 and 52 and is able to cause compression of the spring 56. Spring 58 is stiffer and is not compressed at that stage. When however, the high pressure phase commences, the axial thrust is sufficient to compress spring 58.

In order to eliminate any effect of the fast-fill cylinder portions on the operation of the system once the high pressure phase has commenced, hybrid valves 60, 62 are constructed so that above the pressure of two bar, their flap valves (which have opened to permit relatively low pressure communication through return ports 74), 76 are caused to close and respective ball valves open venting the fast-fill cylinder portions to tank. On completion of braking and release of actuating thrust from foot pedal 22, the system recuperates including return movement of the compressed springs 56, 58 and hybrid vales 60, 62 permit rapid hydraulic return from tank to the increased cylinder portion volumes resulting from piston retraction.

1 A method of controlling an automotive braking system comprising:—
a) providing vehicle wheel brakes comprising friction elements actuated by hydraulic actuator cylinders;
b) providing a hydraulic control system for said vehicle wheel brakes and comprising a control arranged to actuate a hydraulic master cylinder connected to said actuator cylinders; and
c) providing said hydraulic control system comprising independent hydraulic sub-systems controlling respective ones of said actuator cylinders of respective ones of said brakes;
d) providing said master cylinders comprising tandem independent master cylinder portions respectively connected to said sub systems to actuate same; and
e) providing said master cylinder portions further comprising a fast fill cylinder of larger diameter than said tandem master cylinders and connected to one of said sub systems to fast-fill same;
characterised by
f) providing said master cylinder constructed to provide two-stage operation of both of the independent hydraulic sub-systems by means of hydraulically independent cylinder portion pairs, each pair comprising a cylinder portion of each of two differing dimensions; and
g) providing, each master cylinder portion pair comprising said larger diameter fast-fill cylinder portion adapted to enable clearances to be taken up quickly and a smaller diameter portion adapted to multiply the force applied thereto from said control by a higher factor, and the method comprising causing same to generate the required braking force by said actuator cylinders on said friction elements in use.

2 A method of controlling a automotive braking system characterised by:
providing a master cylinder constructed to provide two-stage operation of both of two independent hydraulic sub-systems by means of hydraulically independent cylinder portion pairs, each pair comprising a cylinder portion of each of two differing dimensions; and
providing each master cylinder portion pair comprising a larger diameter fast-fill cylinder portion adapted to enable clearances to be taken up quickly and a smaller diameter portion adapted to multiply the force applied thereto from a control by a higher factor, so as to generate the required braking force, in use, by means of actuator cylinders acting on friction elements.

3 A method according to claim 1 or claim 2 characterised by providing said sub-systems comprising actuator cylinders of diagonally opposed vehicle wheel brakes.

4 An automotive braking system comprising:—
a) vehicle wheel brakes comprising friction elements actuated by hydraulic actuator cylinders;
b) a hydraulic control system for said vehicle wheel brakes and comprising a control arranged to actuate a hydraulic master cylinder connected to said actuator cylinders; and
c) said hydraulic control system comprising independent hydraulic sub-systems controlling respective ones of said actuator cylinders of respective ones of said brakes;
d) said master cylinders comprising tandem independent master cylinder portions respectively connected to said sub systems to actuate same; and
e) said master cylinder portions further comprising a fast fill cylinder of larger diameter than said tandem master cylinders and connected to one of said sub systems to fast-fill same;
characterised by
f) said master cylinder constructed to provide two-stage operation of both of the independent hydraulic sub-systems by means of hydraulically independent cylinder portion pairs, each pair comprising a cylinder portion of each of two differing dimensions; and
g) each master cylinder portion pair comprising said larger diameter fast-fill cylinder portion adapted to enable clearances to be taken up quickly and a smaller diameter portion adapted to multiply the force applied thereto from said control by a higher factor, so as to generate the required braking force by said actuator cylinders on said friction elements in use.

5 An automotive braking system characterised by a master cylinder constructed to provide two-stage operation of both of two independent hydraulic sub-systems by means of hydraulically independent cylinder portion pairs, each pair comprising a cylinder portion of each of two differing dimensions; and
g) each master cylinder portion pair comprising a larger diameter fast-fill cylinder portion adapted to enable clearances to be taken up quickly and a smaller diameter portion adapted to multiply the force applied thereto from a control by a higher factor, so as to generate the required braking force, in use, by means of actuator cylinders acting on said friction elements.

6 A system according to claim 4 or claim 5 characterised by said sub-systems comprising actuator cylinders of diagonally opposed vehicle wheel brakes.

7 A master cylinder assembly adapted for use in accordance with a method according to any one of claims 1 to 3.
